(19) United States
(12) Patent Application Publication
(10) Pub. No.: US 2003/0040821 A1
(43) Pub. Date: Feb. 27, 2003

(54) System and method for portable personal diabetic management

(76) Inventor: Christopher Case, Logan, UT (US)

Correspondence Address: Siemens Corporation, Intellectual Property Department, 186 Wood Avenue South, Iselin, NJ, 08830, US

(21) Appl. No.: 09/938,449

(22) Filed: Aug. 24, 2001

(51) Int. Cl. G06F 17/00

(52) U.S. Cl. 700/90; 600/300

(57) ABSTRACT

The Portable Personal Diabetic Management System (PPDMS) is a portable data processing unit that calculates the carbohydrate and nutritional content of meals, calculates the insulin dosage for the meal based on the carbohydrate information, logs the nutritional data that it collects, logs the insulin dosage a user actually takes, logs blood sugar test results, and performs analysis of the collected data.

### TECHNICAL FIELD OF THE APPLICATION

This invention relates generally to diabetic management, and more specifically to a system and method of portable diabetic management for calculating the carbohydrate and nutritional content of meals; calculating an insulin dosage based on the carbohydrate information; logging the nutritional data, insulin dosage taken, and sugar test results; and performing analysis of the collected data.

### BACKGROUND OF THE INVENTION

The conventional method for determining an insulin dosage for a diabetic requires the completion of several time consuming steps. The insulin/carbohydrate ratio must first be determined. This ratio is unique for each individual and generally requires the individual to measure and record all carbohydrate consumption for several weeks. In addition, the individual must carefully measure and record blood sugar levels several times each day. The blood sugar levels indicate how an individual's metabolism responds to the consumption of specific quantities of carbohydrates. The individual determines the insulin/carbohydrate ratio by dividing the total short acting insulin injected over this period by the individual's total carbohydrate intake. If the blood sugar levels are too high or too low after using this newly calculated ratio, the ratio must be adjusted and the entire process repeated.

Determining the insulin/carbohydrate ratio in some people is further complicated by their inconsistent response to carbohydrate intake. For example, a diabetic may have a different carbohydrate/insulin ratio in the morning than in the afternoon and evening. In this case, the diabetic must calculate separate carbohydrate/insulin ratios for each time period. Once the diabetic determines the ratios, the diabetic calculates insulin dosages by multiplying the appropriate ratio by the total carbohydrates consumed during a meal.

There are a number of disadvantages in determining the insulin dosage with the conventional method. For example, determining the carbohydrates consumed in a meal requires the diabetic to carefully measure the foods in the meal. This involves use of measuring cups, scales, food labels, reference books to look up carbohydrate values for foods that have no labels (i.e., an apple), and a calculator. Accordingly, determining carbohydrates in a meal is time consuming and difficult. It is nearly impossible to perform this task at a restaurant without significant special effort.

Another complication in determining the proper insulin dosage is that the diabetic's insulin/carbohydrate ratio can change as the diabetic's lifestyle changes and as the diabetic grows older. In order to keep up with these changes, the diabetic must continuously record all carbohydrates consumed as well as blood test results. The diabetic must also constantly analyze and monitor this data.

Accordingly, there is a need to provide a method that automates the process of successfully managing a diabetic's blood sugar levels.

### SUMMARY OF THE INVENTION

The present invention automates the daily error prone tasks that diabetics must accomplish to control their blood sugar. Using insulin to carbohydrate ratio (hereinafter referred to as counting carbs) is the method that most doctors prescribe to diabetics for assistance in controlling blood sugar. The entire process of controlling blood sugar by counting carbs is extremely difficult. The portable personal diabetic management system (PPDMS) as described herein, through automation of the carb counting process, eliminates most of that burden placed on the diabetic The PPDMS measures and reports nutritional information for a meal as a whole and for each individual item in the meal. The PPDMS minimizes the intrusion in a diabetic's normal eating routines. Thus, the user should be able to use normal plates, bowls, cups, etc, and the user should not be required to rely on a special tray or bowl to measure values on a scale. The user is not required to measure each food item separately. The diabetic is able to add new food information quickly and easily.

The invention may be better appreciated from the following figures, taken together with the accompanying Detailed Description of the Invention.

### BRIEF DESCRIPTION OF THE DRAWINGS

The invention will now be described with reference to the accompanying figures, wherein:

FIG. 1A is an overview block diagram of the portable personal diabetic management system (PPDMS) of the present invention interfaced via the Internet with a doctor's office.

FIG. 1B is an overview block diagram of the PPDMS interfaced with a computer.

FIG. 2A is a block diagram of an embodiment of a PPDMS.

FIG. 2B is a bock diagram of another embodiment of a PPDMS.

FIG. 2C is a block diagram of still another embodiment of a PPDMS.

FIG. 2D is a bock diagram of still another additional embodiment of a PPDMS.

FIG. 3 shows a flow chart of a nutrition measurement method of the PPDMS of the present invention.

FIG. 4 shows a flow chart of a carbohydrate/insulin logging method of the PPDMS of the present invention.

FIG. 5 shows a flow chart of a blood sugar logging method of the PPDMS of the present invention.

FIG. 6 shows a flowchart of a method to calculate an insulin/carbohydrate ratio.

FIG. 7A shows an exemplary insulin/carbohydrate ratio database of the present invention.

FIG. 7B shows a nutrition/insulin database of the present invention.

FIG. 7C shows exemplary data fields of the nutrition information of the nutrition/insulin database of FIG. 7B.

FIG. 7D shows an exemplary blood sugar database of the present invention.

FIG. 8A is an exemplary PPDMS start screen.

FIG. 8B is an exemplary PPDMS data entry screen for input of a food name.

FIG. 8C is an exemplary PPDMS update display of nutritional information.

FIG. 8D is an exemplary PPDMS display result of nutritional information and an insulin dosage for a specific user.

FIG. 8E is an exemplary PPDMS data entry screen for input of another food name.

FIG. 9 shows exemplary data structures of the weight measurement module 229 of FIGS. 2A-2D.

FIG. 10 shows an exemplary nutrition fact record.

### DETAILED DESCRIPTION OF THE PREFERRED EMBODIMENTS

The following description is provided to enable any person skilled in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

I. General Discussion

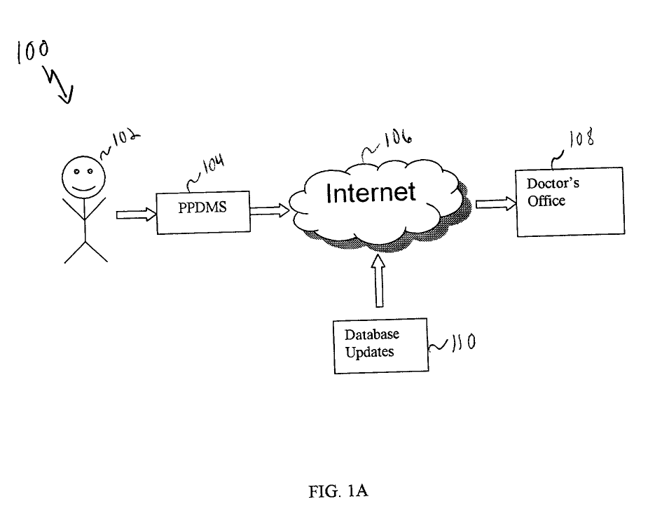

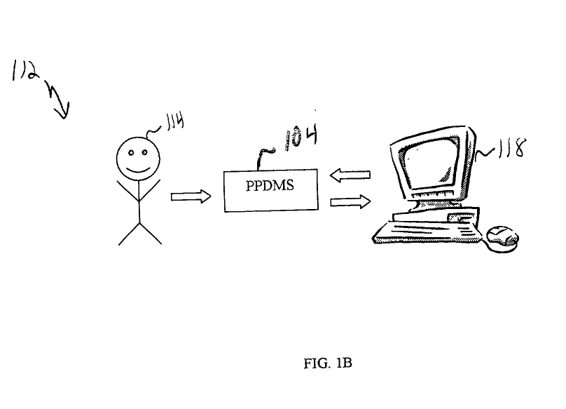

Before discussing details of the present invention, an example of a data processing system implementing an embodiment of the present invention is discussed in the following section. Referring first to FIG. 1, an example of a data processing system in accordance with a first embodiment of the present invention may be appreciated. In particular, communication links between the PPDMS 104, the Internet 106, a doctor's office 108 and a database update provider 110 are shown. Also shown is a user 102 of the PPDMS, typically an individual with a sugar problem such as a diabetic. It will be appreciated that the systems communicating with the PPDMS were arbitrarily chosen, and that alternative embodiments may include other systems. One of ordinary skill in the art will understand the PPDMS may also communicate to an Intranet, or any other type of network instead of Internet 106.

It will also be appreciated that the PPDMS is a stand alone portable system and is typically connected to other systems for minimal time periods. For example, PPDMS 104 enables the user 102 to communicate the information stored in its databases via the Internet 106 or any other available network to a doctor's office 108 or healthcare provider. PPDMS 104 also enables updates of its programs and data from database update provider 110. It will be appreciated that there are a number of different methods for enabling the PPDMS 104 to receive and send data to clients and servers of other computer sites.

For example, referring now to FIG. 1B, the PPDMS 104 is connected directly to a computer 118. Without a network, the PPDMS 104 sends data directly to the computer 118, and receives database and program updates directly from the computer 118.

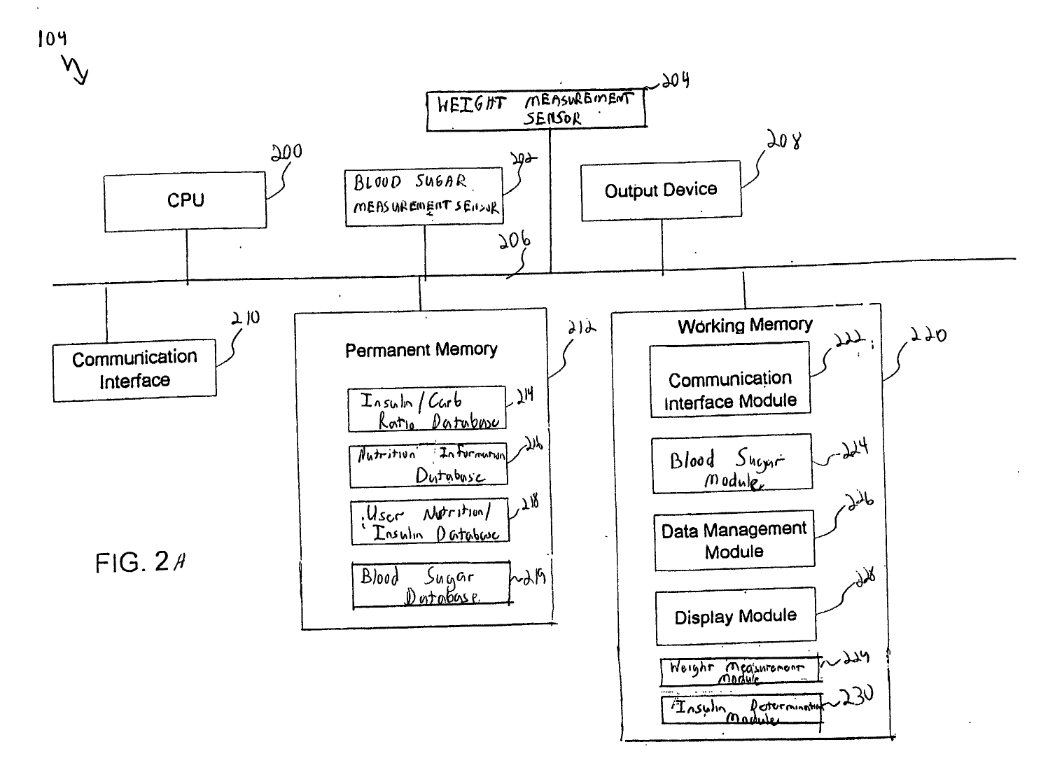

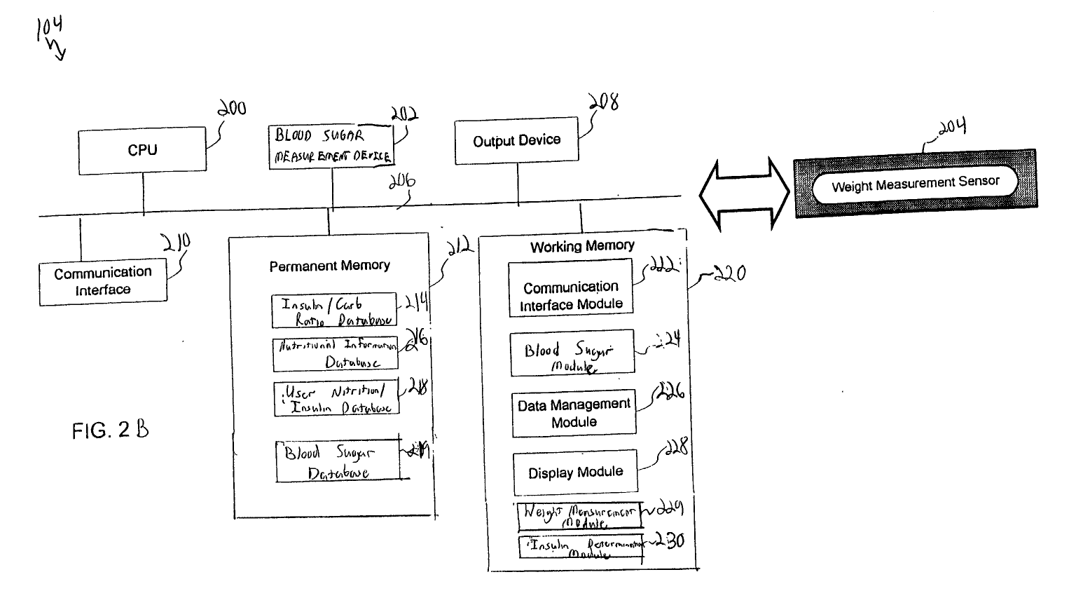

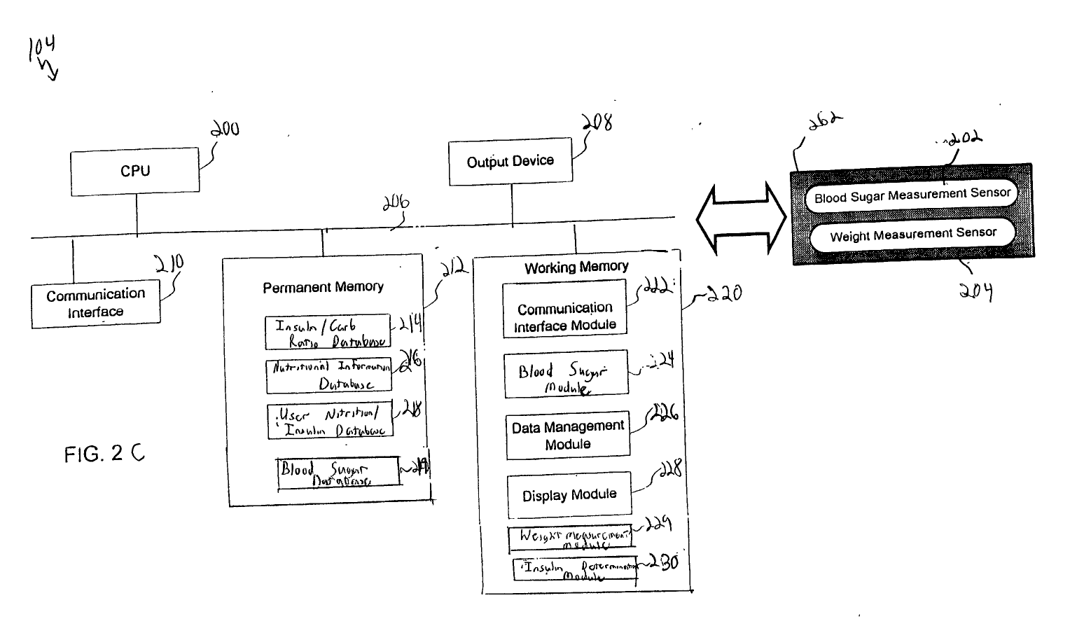

Referring now to FIG. 2A, a block diagram illustrating details of an embodiment of the PPDMS 104 may be better appreciated. PPDMS 104 includes a processor 200 coupled to a communications channel 206. PPDMS further includes input devices such as a blood sugar measurement sensor 202 for measuring a user's blood sugar and a weight measurement sensor 204 for measuring the weight of food to be consumed by the user. PPDMS also includes an output device 208 such as a liquid crystal display (LCD) display, a communications interface 210, permanent memory 212 such as a magnetic disk, and working memory such as Random-Access Memory (RAM), each coupled to the communications channel 206. One skilled in the art will recognize that, although permanent memory 21 and working memory 220 are illustrated as separate units, permanent memory 21 and working memory 220 can be distributed units, integral units or portions of the same unit.

Permanent memory 212 includes an insulin/carb ratio database 214, nutrition information database 216, user nutrition/insulin database 218 and blood sugar database 219. The insulin/car ratio database 214 preferably includes the user's last ratio entry calculated for each time period. The nutrition information database 216 includes all the nutrition information, such as carbohydrates and fats, for each specific type and brand of food. The user nutrition/insulin database 218 includes an historical record of a user's specific nutritional intake and insulin dosage as determined by PPDMS 104. The blood sugar database 220 includes an historical record of the user's blood sugar as measured by blood sugar measurement sensor 202.

Working memory 224 includes a communication interface module 222, a blood sugar module 278, a data management module 226, a display module 228, a weight measurement module 229 and an insulin determination module 230. More specifically, the blood sugar module 278 drives the measurement of the blood sugar, the weight measurement module 229 drives the measurement of the food to be consumed, and the insulin determination module 230 performs the analysis and calculations to determine a user's insulin dosage. One of ordinary skill in the art will recognize that the modules are previously stored in permanent memory 212 and when executed are loaded into working memory 220.

Referring now to FIGS. 2B to 2D, alternative embodiments of the PPDMS 104 may be better appreciated. In the embodiment shown in FIG. 2B, the PPDMS 104 includes an external scale that includes a weight measurement sensor 204 that interfaces with the other components of this hand held unit. In the embodiment shown in FIG. 2C, the PPDMS 104 includes a device inclusive of a blood sugar measurement sensor 202 and the weight measurement sensor that interfaces with the other components of this hand held unit. In the embodiment shown in FIG. 2D, the PPDMS 104 includes two separate devices, one a weight measurement sensor 204, and the other a blood sugar measurement sensor that independently interfaces with the other components of this hand held unit. It will be appreciated that these embodiment are only exemplary of the numerous alternative hardware and software configurations that may be employed to implement PPDMS 104 of the present invention.

PPDMS 104 provides the user maximum portability and reliability. In an embodiment of the invention, PPDMS 104 may be implemented with a PALM IIIXE PDA, manufactured by the PALM CORPORATION with a principle place of business in Santa Clara, Calif., and is attached to an OHAUS SCOUT II electronic balance, manufactured by OHAUS with a principal place of business in Pine Brook, N.J., through the serial cradle of the PALM IIIXE. One of ordinary skill in the art will recognize that the PALM IIIEX PDA and OHAUS SCOUT II electronic balance are provided only as examples and that the present invention may be implemented with alternative components.

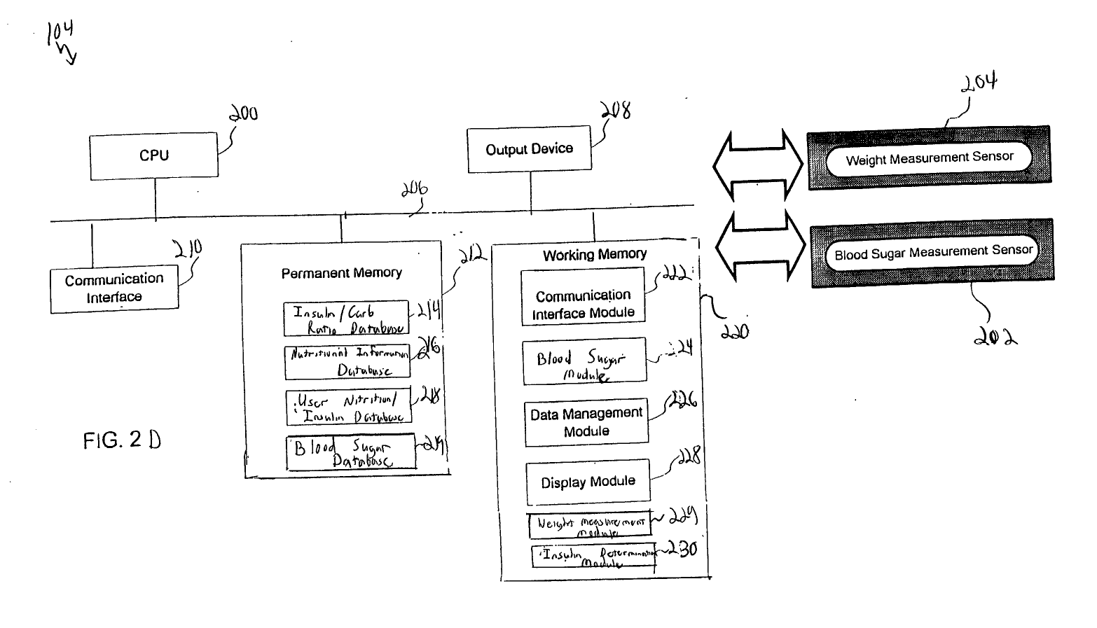

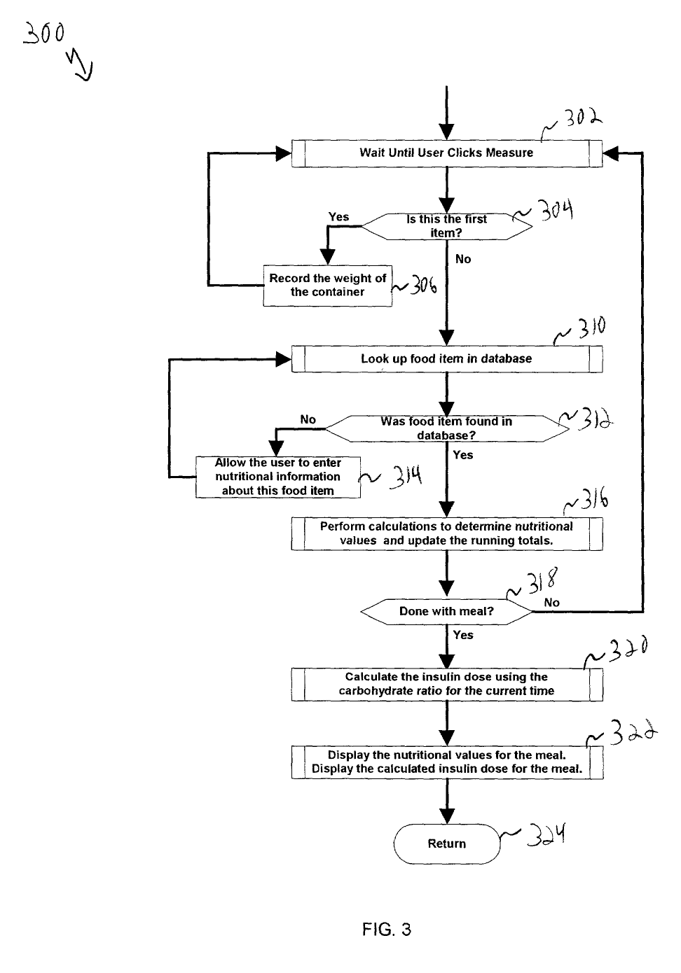

Referring now to FIG. 3, a flow chart 300 of the nutrition measurement process of the present invention may be better appreciated. The process begins in step 302 when a user clicks measure shown on an input screen of the hand held device of the PPDMS 104. In step 304, weight measurement module 229 determines whether this is the first food item. If so, in step 306, weight measurement sensor 204 determines the weight of the food container, and weight measurement module 229 records that weight. If not, data management module 226 looks up the food item in the nutritional information database 218 (See FIGS. 7B & 7C). In step 312, if the food item is not found in the database, the user may enter the nutritional information about this food directly into the PPDMS 104. It will be appreciated that although not shown, a user may request and obtain the nutrition information from a database update system 110 via the Internet, Intranet or stand-alone computer.

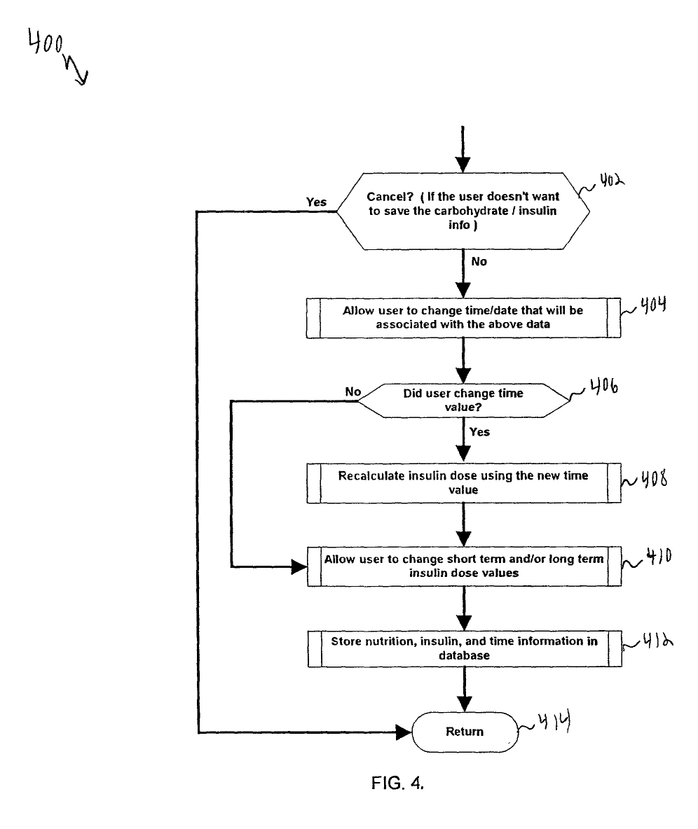

In step 312, if the food item is found in the nutrition information database 216, insulin determination module 230 determines the nutritional values of the food item and updates the user nutrition/insulin database 218 and the running totals. In step 318, display module 228 queries the user whether the meal is done. If not, steps 302 to 318 are performed for each additional food item. If the meal is done, in step 320 insulin determination module 230 determines the insulin dosage based upon the insulin/carb ratio retrieved from the insulin/carb ratio database 214 (See FIG. 7A). The retrieved ratio will correlate with the specific time period of the user's meal. It will be appreciated that the insulin/carb ratio will vary depending upon the time period of the day. Since this ratio directly effects the determined insulin dosage, it is necessary to retrieve the ratio from the appropriate time period. In step 322, display module 228 displays the users nutritional values and insulin dosage for the meal. In step 324, the PPDMS process continues to the flowchart shown in FIG. 4.

It will be appreciated that there are two methods a user may employ to measure food. In the first method, the user starts with an empty container and then adds food to it. In the second method, the user starts with a full container and then removes food from it. The overall method for determining food weight is:

Wₙ=|W_{T}−W_{P}|

where

Wₙ=actual weight of food n

W_{c}=weight of the container object

W_{T}=W_{c}+W₁+W₂+W₃+ . . . +Wₙ

W_{P}=W_{c}+W₁+W₂+W₃+ . . . +Wₙ₋₁

When a user is finished with a container, W_{P} and W_{T} are initialized to zero and the process starts over. This method allows the scale to be completely analog except for the ADC. The end user does not need to separately measure each food item in the meal. This allows food to be served in a normal manner.

Referring now to FIG. 4, a flow chart 400 for logging the users insulin and carbohydrate information may be better appreciated. The process begins in step 402 when display module 228 queries the user whether the user will save or cancel the carb and insulin information. If the user clicks “cancel” the process jumps to step 414 and ends. If the user clicks to “save” the results, in step 404 the user may change the time/date that will be associated with the insulin and carb information. In step 406, the insulin determination module 230 determines whether the user changed the time value. If the user did change the time value, in step 408 the insulin determination module 230 determines the insulin dosage using the new time value. If the user did not change the time value, in step 406 the process continues to step 410. In step 410, the user may change short and/or long term insulin dosage values. In step 412, data management module 226 stores nutrition, insulin and time information in the user nutrition/insulin database 228. In step 414 this process ends.

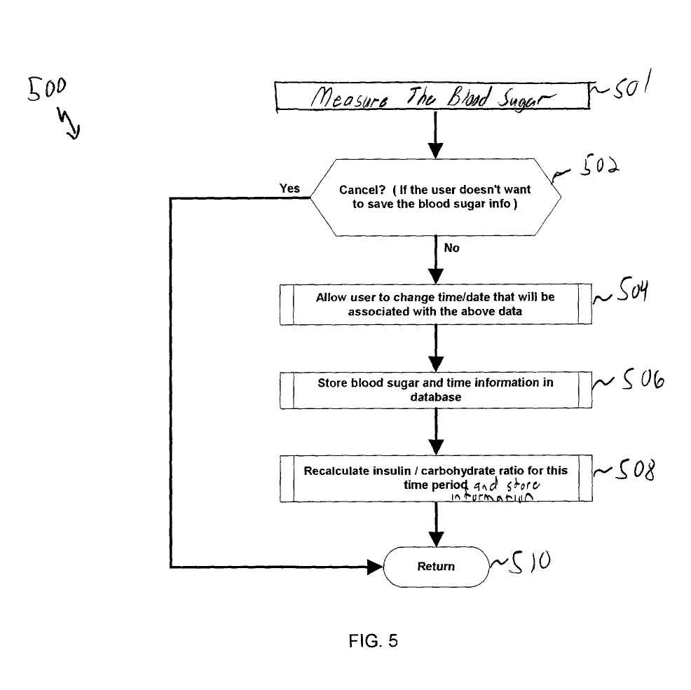

Referring now to FIG. 5, a flow chart 500 for logging the user's blood sugar may be better appreciated. The process begins in step 501 when the user provides a sample of blood sugar to blood sugar measurement sensor 202.

Blood sugar module 202 determines the blood sugar information. In step 502, display module 228 queries the user whether the user will save or cancel the blood sugar information. If the user clicks “cancel” the process jumps to step 510 and ends. If the user clicks to “save” the results, in step 504 the user may change the time/date stamp that will be associated with the blood sugar information. In step 506, data management module 226 stores blood sugar and time information in the blood sugar database 219 (See FIG. 7D). In step 508, insulin determination module 230 determines the insulin/car ratio for this time period, and data management module 226 saves the results in the user nutrition/insulin database 218. In step 510 this process ends.

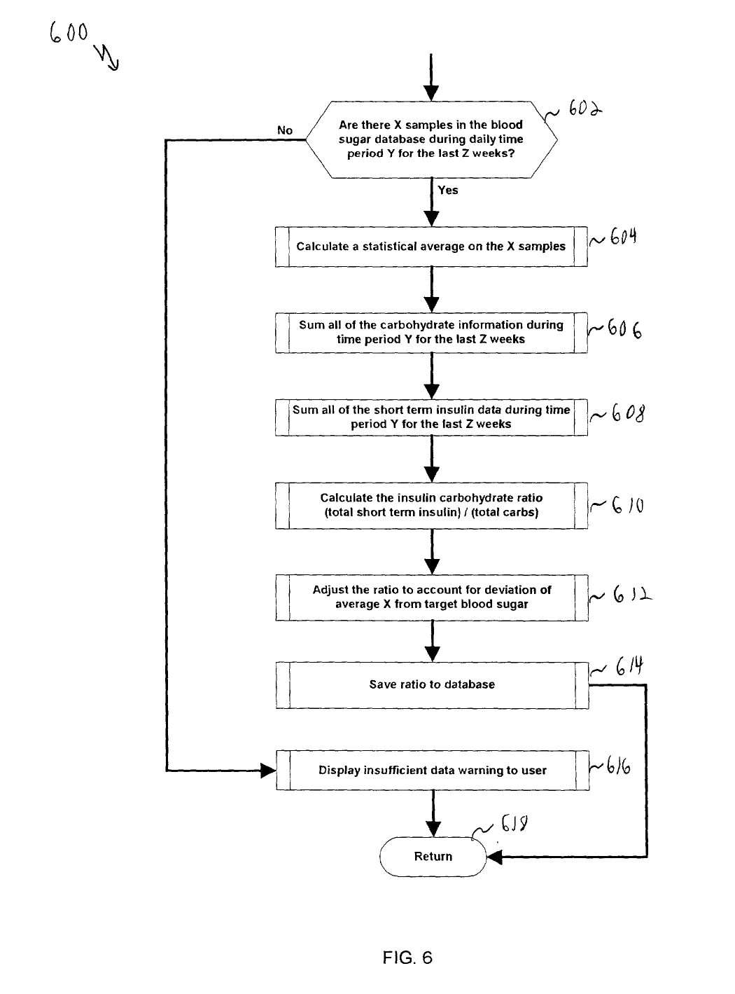

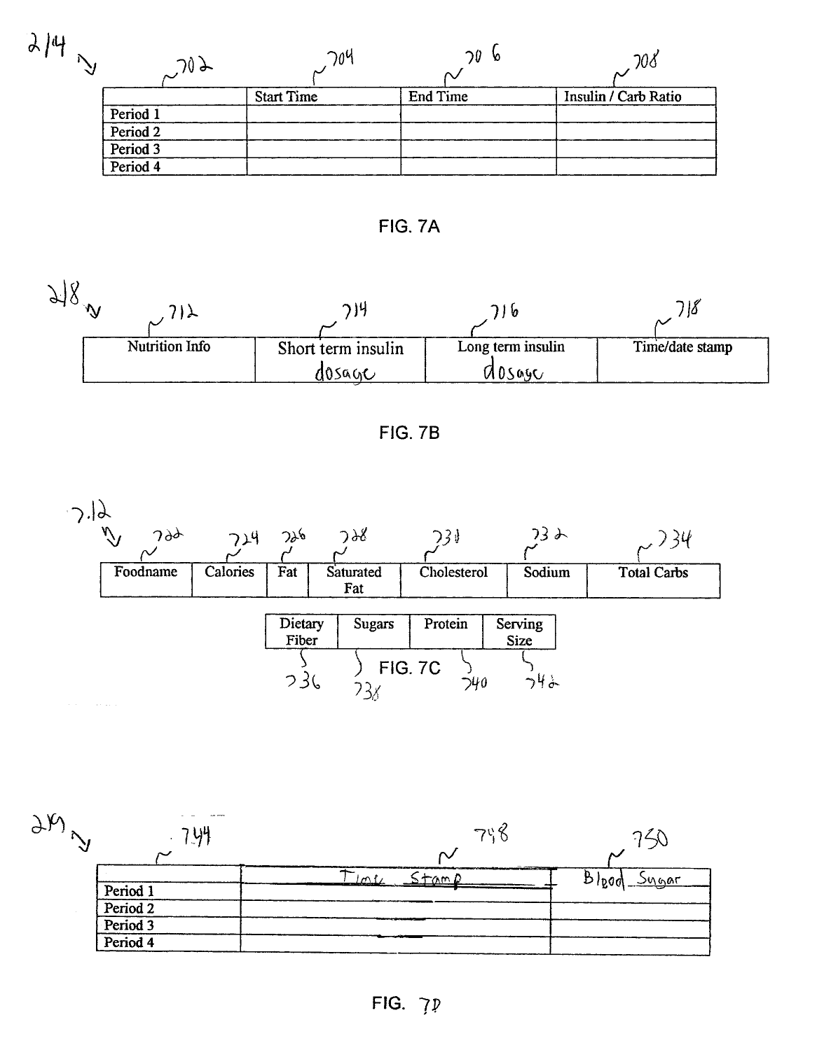

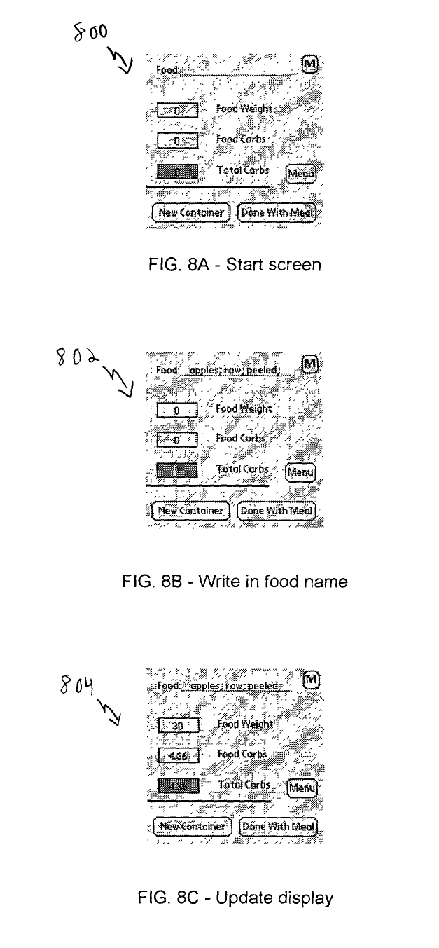

Referring now to FIG. 6, a flow chart 600 of the process to determine the insulin/carb ratio may be better appreciated. The process begins in step 602 with the insulin determination module 230 determining whether there are “X” samples in the blood sugar database 219 during daily time period “Y” for the last “Z” weeks. If not, the process jumps to step 616 and display module 228 displays an insufficient data warning to the user.

If there is sufficient blood sugar data, in step 604 insulin determination module 230 calculates a statistical average on the “X” samples. In step 606, insulin determination module 230 sums all of the carb information during the time period “Y” for the last “Z” weeks. In step 608, insulin determination module 230 sums all of the short term insulin data during timer period “Y” for the last “Z” weeks. In step 610, insulin determination module 230 calculates the insulin carb ratio by dividing total short term insulin by the total number of carbs. It will be appreciated that data management module 230 retrieves the carbohydrate and short term insulin information from user nutrition/insulin database 218 for insulin determination module 230.

In step 612, insulin determination module 230 adjusts the nutrition/insulin ratio to account for deviation of average blood sugar “X” from the targeted blood sugar level. In step 614, data management module 226 saves the ratio to insulin/carb ratio database 214. It will be appreciated that each ratio is associated with a specific time period since a user's reaction to carb intake may vary during a given day. In step 614 the process ends.

Referring now to FIG. 7A, an exemplary insulin/carb ratio database 214 may be better appreciated. As shown, database 214 for each time period 702 includes a start time 704, an end time 706 and an insulin/carb ratio 708. It is preferable that only the prior day's values are included in database 700. However, one of ordinary skill in the art will recognize that historical insulin/carb data could be stored for the purpose of tracking the ratio.

Referring now to FIG. 7B, an exemplary user nutrition/insulin database 218 may be better appreciated. As shown, each time period of database 218 includes nutrition information 702, short term insulin 714, long term insulin 716 and a time/date stamp 718.

Referring now to FIG. 7C, the nutrition information 702 of FIG. 7B may be better appreciated. As shown, nutrition information 702 includes a food name 722, calories 724, fat 726, saturated fat 728, cholesterol 730, sodium 732, total carbs 734, dietary fiber 736, sugars 738, protein 740 and serving size 742. It will be appreciated that this list is only exemplary and additional nutritional information could also be included.

Referring now to FIG. 7D, an exemplary blood sugar database 219 may be better appreciated. As shown, for each time period 744, database 219 includes a time stamp 748 and blood sugar 750

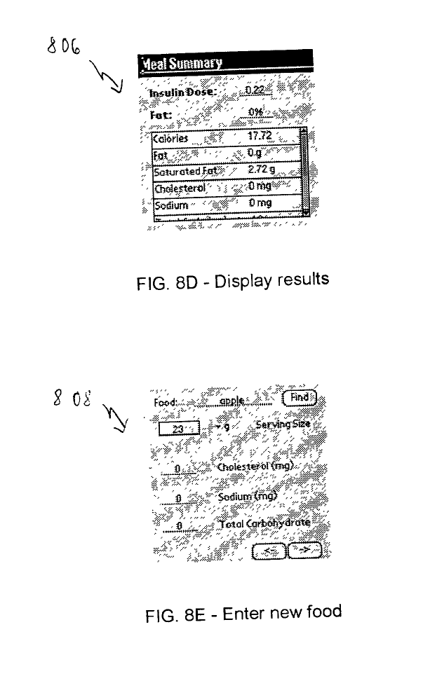

Referring now to FIGS. 8A-8E, the use of PPDMS may be better appreciated. The example begins with a user that wants to measure a meal that starts with sliced applies. First, the user turns the hand held PPDMS on. FIG. 8A shows a screen provided by display module 228 that a user may view. In response the user places an empty container on the scale and clicks (M) measure. Weight measurement sensor 204 obtains and temporarily stores the weight in working memory 220.

In FIG. 8B, the user then enters the food name on the food-input line and then clicks (M) measure. In response, the nutrition analysis as described in FIG. 3 occurs. Insulin determination module 230 calculates the nutritional amounts based on the values in nutrition information database 216 and the measured weight of the food. As shown in FIG. 8C, display module 228 displays the nutritional results for the entered food.

The user may continue to enter additional food items to the container and click measure after each entry. It will be appreciated that the user may also use additional containers. When the user completely accounts for all of the food in the meal, the user may click the “Done With Meal” button. In response, as shown in FIG. 8D, display module 228 displays the meal total nutritional results. Display module 228 also displays the time/date stamp 718,short-term insulin dosage 714 and long term insulin dosage 716. It will be appreciated that the long-term insulin dosage is not shown in FIG. 8D.

If data management module 226 had not located sliced apples in nutrition information database 226, the user has the opportunity to enter the nutritional data. In FIG. 8E, display module 228 displays an input screen for entry of nutritional information for a specific food. It will be appreciated that the user may alternatively retrieve the nutritional information from a database update provider 110 via the Internet, Intranet or stand-alone computer.

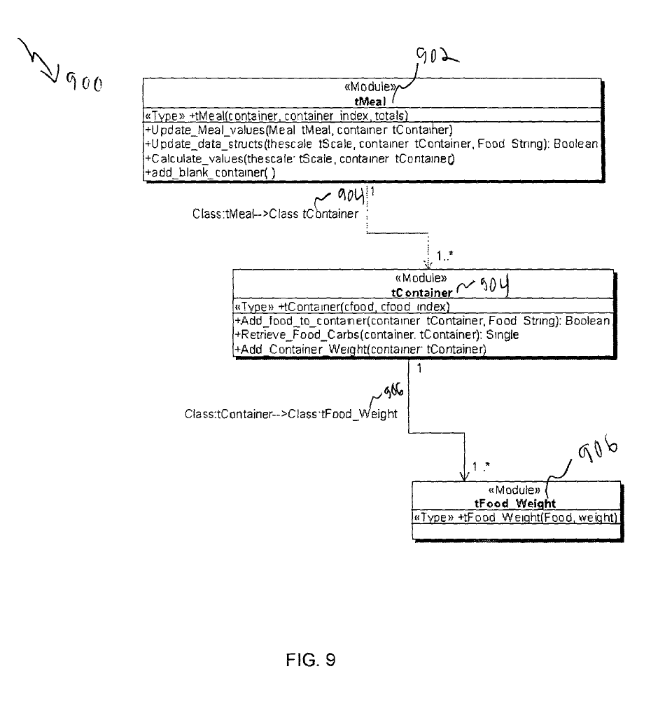

Referring now to FIG. 9, an embodiment of the data structures for weighing the food and calculating nutritional information for a given meal may be better appreciated. As shown, an instant of tMeal 902 consists of multiple container instances (tcontainer 904) and a running total of nutritional information (of type tNutr_FactsRecord) for the meal. The functions of tMeal 902 manipulate the included data structures.

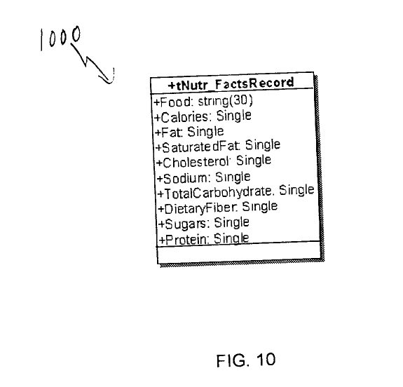

An instance of tContainer 904 consists of multiple food instances of type tFood_Weight 906 and the associated function listed for manipulating the included data structures. An instance of tFood_Weight 906 consists of a single food record instance of type tNutr_FactsRecord and the weight of the food. The information stored in tNutr_FactsRecord object is shown in FIG. 10. It will be appreciated that tNutr_FactsRecord object provides the data structure for user nutrition/insulin database 218.

It will also be appreciated that the data structures in FIG. 9 allow a user to measure the nutritional value of the user's meal without the use of special containers. A user simply places a typical container on the scale and adds to or removes food from the container. These data structures also allow a meal to be reviewed. For example, if a user want to view detailed information for a particular food item, the information can be easily retrieved from these data structures.

One of ordinary skill in the art will recognized that FIG. 9 shows an embodiment of data structures and modules, and that other embodiments may implement PPDMS with alternative data structures and modules.

It can therefore be appreciated that a new and novel system and method for portable personal diabetic management has been described. It will be appreciated by those skilled in the art that, given the teaching herein, numerous alternatives and equivalent will be seen to exist which incorporate the disclosed invention. Further, this teaching can be applied to other fields. For example, if the insulin calculations are not included, the device could assist people who are trying to maintain a diet, such as athletes, people with heart problems, and those who are trying to lose weight. As a result, the invention is not to be limited by the foregoing exemplary embodiments, but only by the following claims.

We claim:

1. A method for monitoring and maintaining a diet on a portable device, comprising:
receiving a request to measure a weight of a food;
automatically determining, in response to the request, the weight of the food;
automatically retrieving nutritional values of the food based on nutritional information; and
displaying the nutritional values of the food.

2. The method of claim 1 further comprising:
storing the nutritional values of the food.

3. The method of claim 1 further comprising:
automatically determining a first insulin/carbohydrate ratio.

4. The method of claim 3, wherein the automatically determining a first insulin/carbohydrate ratio comprises:
determining a statistical average of a quantity of blood sugar samples from at least one time period;
summing carbohydrate data from the at least one time period;
summing insulin dosage values from the at least one time period; and
quantifying the insulin/carbohydrate ratio by dividing the insulin dosage values by the carbohydrate data.

5. The method of claim 4 further comprising:
adjusting the insulin/carbohydrate ratio to account for a deviation from the statistical average of the quantity of blood sugar samples from a target blood sugar value.

6. The method of claim 3 further comprising:
automatically determining a first insulin dosage based on the first insulin/carbohydrate ratio and the nutritional values of the food.

7. The method of claim 6 further comprising:
displaying the first insulin dosage.

8. The method of claim 6 further comprising:
storing the first insulin dosage.

9. The method of claim 8 further comprising:
storing a time stamp with the first insulin dosage.

10. The method of claim 3, wherein the automatically determining a first insulin/carbohydrate ratio is based on a carbohydrate sensitivity for a time period.

11. The method of claim 10 further comprising:
storing a start time of the time period.

12. The method of claim 10 further comprising:
storing an end time of the time period.

13. The method of claim 1, wherein the nutritional values of the food include at least one selected from the group consisting of (i) calories; (ii) fat; (iii) saturated fat; (iv) cholesterol; (v) sodium; (vi) total carbohydrates; (vii) dietary fiber; (viii) sugars; and (iv) protein.

14. The method of claim 1 further comprising:
receiving a first blood sugar value.

15. The method of claim 14 further comprising:
storing the first blood sugar value.

16. The method of claim 15 further comprising:
storing a first time period with the blood sugar value.

17. The method of claim 14 further comprising:
receiving a second time period.

18. The method of claim 17 further comprising:
receiving a second blood sugar value in association with the second time period.

19. The method of claim 18 further comprising:
storing the second blood sugar value and the second time period.

20. The method of claim 19 further comprising:
determining a second insulin/carbohydrate ratio for the second time period.

21. The method of claim 3 further comprising:
receiving a time period to determine a second insulin/carbohydrate ratio; and
automatically determining a second insulin dosage based on the second insulin/carbohydrate ratio.

22. The method of claim 21 further comprising:
storing the second insulin/carbohydrate ratio, the time period and the second insulin dosage.

23. A method for diabetic management provided on a portable device, comprising:
receiving a request to measure a weight of a food;
automatically determining, in response to the request, the weight of the food;
automatically retrieving nutritional values of the food based on nutritional information and the weight of the food; and
determining an insulin dosage based on the nutritional values of the food.

24. The method of claim 23, wherein determining the insulin dosage comprises determining an insulin/carbohydrate ratio.

25. A system for monitoring and maintaining a diet, the system comprising:
a communication interface module for receiving request to measure a weight of a food;
a weight measurement module for automatically determining, in response to the request, the weight of the food;
a data management module for automatically retrieving nutritional information; and
an insulin determination module for determining a nutritional value of the food based on the nutritional information and the weight of the food.

26. The system of claim 25 further comprising a display module for displaying the nutritional value of the food.

27. The system of claim 25, wherein the database manager stores the nutritional value of the food.

28. The system of claim 25, wherein the insulin determination module automatically determines an insulin/carbohydrate ratio.

29. The system of claim 28, wherein the insulin determination module determines a first insulin/carbohydrate ratio by determining a statistical average of a quantity of blood sugar samples from at least one time period, summing carbohydrate data from the at least one time period, summing insulin dosage values from the at least one time period; and quantifying the insulin/carbohydrate ratio by dividing the insulin dosage values by the carbohydrate data.

30. The system of claim 29 wherein the insulin determination module automatically determines a first insulin dosage based on the insulin/carbohydrate ratio and the nutritional values of the food.

31. The system of claim 30 wherein the communication interface module receives a blood sugar value.

32. The system of claim 31 wherein the data management module stores the blood sugar value.

33. The system of claim 32 wherein the data management module stores a first time stamp with the blood sugar value.

34. A computer-readable medium encoded with instructions for directing a processor to:
receive a request to measure a weight of a food;
automatically determine, in response to the request, the weight of the food;
automatically retrieve nutritional values of the food based on nutritional information; and
display the nutritional values of the food.

35. A computer-readable medium encoded with instructions for directing a processor to:
receive a request to measure a weight of a food;
automatically determine, in response to the request, the weight of the food;
automatically retrieve nutritional values of the food based on nutritional information and the weight of the food; and
determine an insulin dosage based on the nutritional values.

36. The computer-readable medium encoded with instructions of claim 35 further directs a processor to:
determine an insulin/carbohydrate ratio.
